(19) United States
(12) Patent Application Publication
(10) Pub. No.: US 2023/0338955 A1
(43) Pub. Date: Oct. 26, 2023

(54) MICRODEVICES AND PROCESSES TO SEPARATE AND PROCESS MIXED FORENSIC BIOLOGICAL SAMPLES

(71) Applicant: Virginia Commonwealth University, Richmond, VA (US)

(72) Inventors: Sarah Williams, West Point, VA (US); Joseph Reiner, Fredericksburg, VA (US); Tracey Dawson Green, Glen Allen, VA (US)

(21) Appl. No.: 18/304,022

(22) Filed: Apr. 20, 2023

Related U.S. Application Data
(60) Provisional application No. 63/332,808, filed on Apr. 20, 2022.

(51) Int. Cl. B01L 3/00

(52) U.S. Cl. CPC B01L 3/502761; B01L 2200/0647; B01L 2400/0454; B01L 2300/12; B01L 2200/10

(57) ABSTRACT

Microdevices and methods provide for separating cells of a single type from a mixed biological sample containing multiple types of cells. A single microdevice may be configured to allow for separating out cells into multiple groupings, each grouping containing cells of only one cell type. Transfer of separated cells off the microdevice is performed by physical separation of part of the microdevice from a remainder of the microdevice. This step advantageously minimizes accidental cell losses in the transfer. Subsequent analysis may then be performed using non-microfluidic equipment and techniques.

### CROSS-REFERENCE TO RELATED APPLICATIONS

This application claims the benefit of U.S. Provisional Patent App. No. 63/332,808, filed Apr. 20, 2022, the complete contents of which are herein incorporated by reference.

### FIELD OF THE INVENTION

This disclosure generally relates to devices and methods for handling and processing biological evidence and, more particularly, devices and methods for reliable separation of cells in mixed samples for subsequent analysis.

### BACKGROUND

The most common problem encountered by forensic biologists when analyzing biological evidence is that of DNA mixtures. A mixture occurs when two or more individuals' biological fluids or cells are deposited on evidence. This commonly occurs on sexual assault evidence since swabs collected from the victim are likely to contain that victim's cells as well as those of the perpetrator and potentially consensual partners. Other possible mixtures may occur during physical assaults which result in mixtures of blood, saliva, or both on skin, surfaces, or clothing. Ordinarily, the presence of a mixture cannot be detected until the endpoint of the DNA analysis. This slows the process as mixtures with two contributors demand that the analyst deconvolute the mixture, carefully considering the makeup of alleles at each locus. However, studies have shown that variabilities in mixture interpretation procedures exist between laboratories and even between individuals, suggesting that manual interpretation procedures can be subjective, introducing the opportunity for bias. Furthermore, if a mixture has greater than two contributors, this often becomes infeasible to manually process.

Over the past decade, research scientists have been keenly focused on the development of unbiased, objective mixture interpretation strategies that can be used in the forensic DNA community. To address the problem of mixed samples, many laboratories have begun implementing back-end solutions such as probabilistic genotyping software. However, more recent efforts have shifted focus to simpler, more intuitive solutions that seek to separate cellular components of a mixture prior to further laboratory processing; this approach circumvents the need for complex, expensive bioinformatics solutions at the end of the workflow.

Auka et al. (Auka N, Valle M, Cox B D, Wilkerson P D,Dawson Cruz T, Reiner J E, et al. (2019) Optical tweezers as an effective tool for spermatozoa isolation from mixed forensic samples. PLoS ONE 14(2): e0211810. https://doi.org/10.1371/journal.pone.0211810) describe the use of an optical tweezer to trap and separate spermatozoa from a sample which also contained vaginal epithelial cells. The technique involves the drawing up of cell populations via a capillary and transfer to and from glass cover slips. A major unaddressed problem with the Auka et al. approach is that it relies on a number of complex steps (mostly due to the droplet formation and capillary positioning) that will not easily transfer into a forensic lab setting. There remains a need to develop a process that would be readily transferable to the forensics workbench.

### SUMMARY

According to some exemplary embodiments, methods and devices are disclosed which improve upon prior techniques for the handling of mixed biological samples by involving microfluidic-based steps to cell separation. Depending on the embodiment, advantages may include any one, some, or all of: minimized risk of introduction of drop-in alleles to samples, compatibility with certain existing lab procedures (especially forensic lab procedures) for the handling and assessment of biological samples, concurrent or immediately successive separation and isolation of more than one cell type of interest (e.g., all on a single microdevice), reduction or elimination of pipetting of samples containing already low quantities of cells with resultant avoidance of any cell losses associated with pipetting, consistent and reliable transfer of cells off microdevices to other equipment such as non-microdevice laboratory equipment (e.g., centrifuge tubes or the like), and visual verifiability of cell quantities involved in a transfer.

Some exemplary embodiments involve the use of a microchip and optical tweezing (OT) for separation of different cells from a cell mixture. Once cells are separated, such embodiments provide for a reliable transition to non-microchip downstream processing. The transition step involves reliable and verifiable transfer of cell quantities off the microchip.

Some exemplary embodiments include both a microchip design as well as a process designed to separate cell types from mixed forensic biological samples prior to downstream DNA/human identification analysis. Downstream processing may include, for example, cell lysis, amplification of DNA obtained from the cell lysis, and identification of a human (or other entity) from the DNA.

Some embodiments of the disclosure provide a microfluidic-based microdevice platform for laser-initiated rapid microscopic separation of forensically relevant cells. This technology can be used in forensic casework to precisely and accurately isolate cells from a perpetrator away from those of the victim. This, in turn, enables more accurate DNA identification of perpetrators while at the same time reducing case backlogs.

Some exemplary embodiments involve a modular microchip configured to interface with a standard optical tweezer microscopy platform. An exemplary microdevice may be configured to sit on an optical tweezer platform, providing a stage for the manipulation and capture of target cell populations in a microfluidic environment. An exemplary modular microchip may be used alone by forensic labs to separate cells for an existing, downstream validated (manual) workflow. Alternatively, an exemplary modular microchip may be integrated into, for example, a sexual assault microchip with further modules configured for steps which precede or follow after the steps for which the exemplary modular microchip is configured. An exemplary multi-step microchip may replace or provide an alternative to existing chemistry-based separation modules. When an optical tweezer separation module is fully integrated into a multi-step sexual assault microdevice, downstream modules for cell lysis and DNA amplification may remain on-chip, for example. Such devices and their related processes, in some use cases, allow for the faster processing of evidentiary cell mixtures, including sexual assault samples. Another advantage is providing a closed environment for hands-free processing.

An optical tweezer cell separation microdevice module according to this disclosure may be used as a stand-alone device. Alternatively, such an exemplary separation module may be integrated into a larger, multi-step microdevice (such as the device described in US2020/0023366 incorporated herein by reference) for additional automated downstream processing.

Some exemplary embodiments include a microchip-based cell separation module designed specifically for interfacing with a microscope and optical tweezer apparatus. It is unique and advantageous to present embodiments to have an ability to integrate with other backend, closed-system modules. This differs from existing technologies in that it allows for a more discriminatory microscopic separation of cells that is chemistry independent. This allows for improved cell separation specificity and more pristine resulting single source DNA samples.

Some exemplary embodiments include an optical tweezer separation microdevice module used alone, whereas other embodiments include an optical tweezer separation microdevice integrated into a multi-step microdevice. Further embodiments may involve cell tweezing approaches (processes).

While some exemplary embodiments described by this disclosure refer to separation of specific cell types for purposes of illustration (e.g., spermatozoa or epithelial as two examples), exemplary embodiments are suitable for use with other cell types. That is to say, while separation of cell types associated with sexual assaults (sperm and vaginal cell mixtures) may be exemplary, microdevice modules according to this disclosure, whether used alone or as a component of an integrated multi-step microdevice, may be be used to separate any forensically relevant cell types that are microscopically, morphologically distinguishable (including but not limited to external epithelial cells, buccal epithelial cells, blood cells, etc.). In addition to these forensic applications, there are applications for cell separation devices and approaches of this disclosure in the biomedical and broader general biological clinical and research communities.

Many exemplary embodiments herein involve physically sorting out cells of at least one cell type from all other cells of cell types which are not the one cell type. The physical sorting in some embodiments does not require and may not include use of antibodies. The physical sorting leaves cells intact, that is to say, cells are not ruptured or otherwise physically damaged. Only after the sorting, in particular after optical tweezing is completed, may cells in some embodiments be subjected to lysis or other procedures which break apart the cell structure.

This application incorporates by reference herein U.S. patent application Ser. No. 16/484,142, filed Aug. 7, 2019, published as US 2020/0023366 which reflects other work by some of the same inventors to the present application. U.S. patent application Ser. No. 16/484,142 (sometimes referred to herein as the '142 application) describes, for example, microfluidic devices stages and modules which may be incorporated into exemplary embodiments of the present disclosure. Conversely, aspects of exemplary embodiments described in the present disclosure may be incorporated into microdevices described in the '142 application in some embodiments.

### BRIEF DESCRIPTION OF THE DRAWINGS

FIG. 1 is an example general microfluidic design for an exemplary optical tweezer microchip separation module.

FIG. 2 is an example microfluidic design for an exemplary optical tweezer microchip separation module which has multiple trapping zones, trapping channels, and extraction wells to permit the separation of multiple cell types each to its own chamber on a single chip.

FIGS. 3A-3F illustrate an exemplary process for cell separation using a cell separation module of a microdevice.

FIG. 4 is a flowchart of another exemplary process for cell separation using a cell separation module of a microdevice.

FIG. 5 is an example general integrated (multi-step) microfluidic design for a microdevice that includes an optical tweezer module, cell lysis module, and DNA amplification module on a single chip.

FIG. 6 is an exemplary cross-sectional profile illustration of layers in a microdevice.

FIG. 7 is a schematic of an exemplary system of hardware for separating cells.

FIG. 8 is a schematic of an exemplary dual trap setup for optical tweezing.

### DETAILED DESCRIPTION

Some exemplary embodiments comprise, consist of, or otherwise involve microfluidic devices (sometimes referred to as “microdevices” for brevity). An exemplary microdevice may comprise or consist of a chip, e.g. a lab-on-a-chip (LOC). An exemplary microdevice may generally comprise one or more chambers, one or more conduits (e.g. channels) for establishing fluid communication between or among chambers, and one or more valves (e.g. microvalves) for regulating egress from and ingress to chambers and/or the passage and blockage of flow within conduits and channels.

“Chamber(s)” as used herein may be interchangeably referred to as “compartment(s)”. Generally, these may be spaces within a unitary microdevice and typically (but not necessarily) have fixed spatial relationships to one another by virtue of being part of the same unitary device or structure. For instance, a microdevice may have a unitary body of respective cavities which form chambers. Chambers of a chip device or chip system may be described as “on-chip”. Processes carried out by or in such chambers may also be described as “on-chip”. Chambers and conduits are generally spaces defined by one or more walls or other barriers to have a fixed or substantially fixed geometry and volume. The space or spaces of chambers and conduits may be filled (permanently or temporarily, partially or completely) by matter which may move between chambers when desired and permitted.

A chamber generally comprises a sufficient number of boundaries (e.g., walls) to partially or fully enclose a space. A chamber which is configured to retain matter (e.g., prevent egress of the matter), be it temporarily or permanently, may be described as enclosing the matter to be retained. Matter may exit a chamber via a conduit, a valve, a vent, or other opening, if such is provided. In the case of microdevices, chambers and conduits are frequently but not necessarily isolated from direct contamination by environmental agents outside the microdevice. In some instances a chamber or conduit may be hermetically sealed or substantially hermetically sealed with respect to external contaminants (noting that test samples and constituents thereof are not regarded as contaminants in the sense that they may be deliberately introduced into a chamber or conduit).

Chambers may be referred to as upstream or downstream of one another. As between two chambers, where matter moves from the first chamber to the second chamber, the first chamber is “upstream” of the second chamber. Conversely, the second chamber is “downstream” of the first chamber. This characterization is applicable when matter moves directly from the first chamber to the second chamber, and it remains applicable even if further chambers, channels, or valves intervene in the flowpath between the first and second chambers. For example, the expression “a sample moves from a first chamber to a second chamber which is downstream of the first chamber” permits but does not require the possibility of the sample moving through one or more further chambers, conduits, valves, etc. before it reaches the second chamber. By contrast, the expression “a sample moves from a first chamber directly to a second chamber which is downstream of the first chamber” may be used to indicate that no chambers intervene the flowpath between the first and second chambers. Naturally, at least a conduit may exist between the first and second chambers to place them in fluid communication. Alternatively, if the chambers are immediately adjacent to one another, it may be that a valve without any accompanying conduit is sufficient to fluidically connect the two chambers.

Chambers may form circuits, e.g. fluid circuits, and be arranged in a particular sequence or sequences. Like electrical circuit elements, fluid circuit elements may be arranged in series or in parallel. If two circuit elements (e.g., two chambers) are arranged in parallel, matter which passes through one of the chambers cannot also pass through the other of two chambers. In short, two elements in parallel are neither upstream nor downstream of one another, as each belongs to a separate flowpath. By contrast, circuit elements which are in series are by definition part of the same flowpath, and one is necessarily upstream or downstream of the other. Changes in valve states (e.g. open to closed or closed to open) may alter flowpaths in a microdevice such that the relationships of respective chambers (e.g. parallel configuration or series configuration) are subject to change based on the valve states.

In some aspects, the samples that are analyzed by the microdevices described herein comprise, or are reasonably thought to comprise, more than one type of cell. Accordingly, at least one of the types of cells in a sample to be analyzed using an exemplary disclosed microdevice is differentially selectable from other cells types in the sample.

As used in this disclosure, optical tweezing may be referred to interchangeably as optical trapping. Optical tweezers may be referred to interchangeably as an optical trap. Any of these terms may be abbreviated as “OT”. The modifier “optical” may also be omitted in instances for brevity.

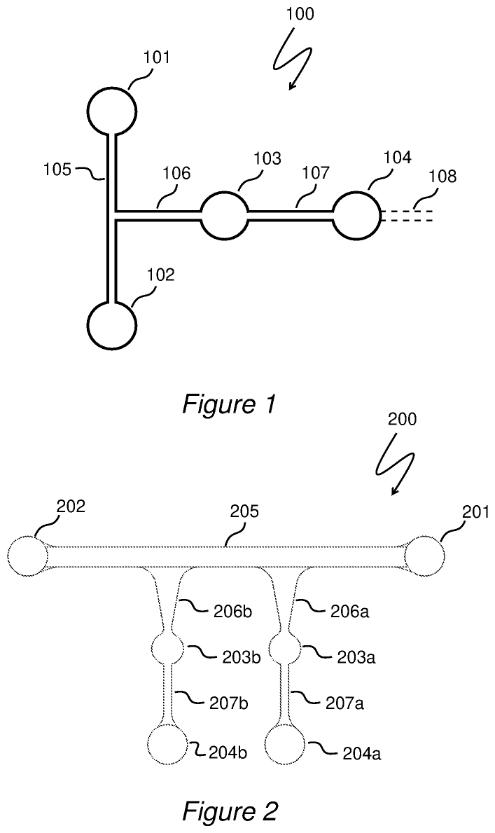

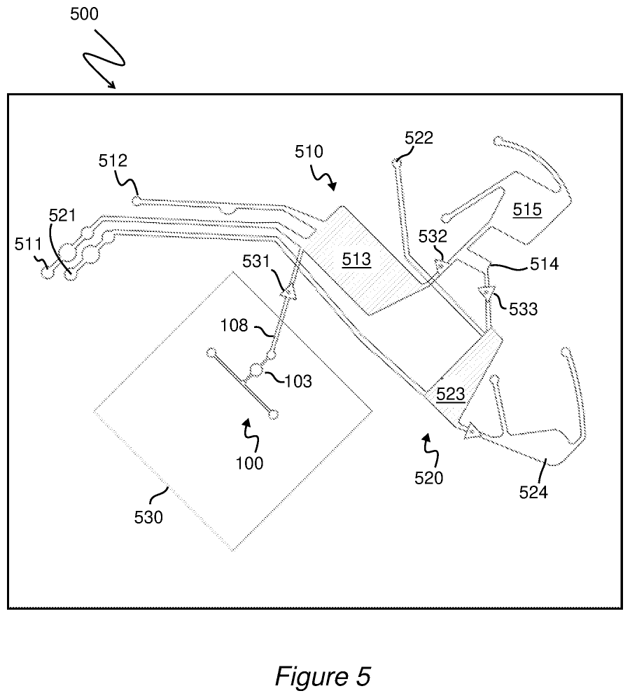

FIG. 1 is an example general microfluidic design for an exemplary optical tweezer microchip separation module 100. Module 100 generally comprises wells 101, 102, 103, and 104. Note that for purposes of this disclosure, “well” may be used to refer to a “chamber”; “well” maybe used to refer to an inlet port; and “well” may be used to refer to an outlet port. Wells 101 and 102 are connected to one another by a channel 105. Channel 105 may be a straight channel which follows the shortest geometric path from well 101 to well 102, for example. Branching from channel 105 is a separate channel 106. Channels 105 and 106 may form an angle such as but not limited to a ninety degree angle, as depicted by FIG. 1. Channel 106 terminates into channel 105 at one end and into well 103 at the other end. Channel 107 meanwhile connects wells 103 and 104. Depending on the embodiment, a further channel 108 may be provided leading off of well 104. Channel 108 is discussed in greater detail below in connection with FIG. 5.

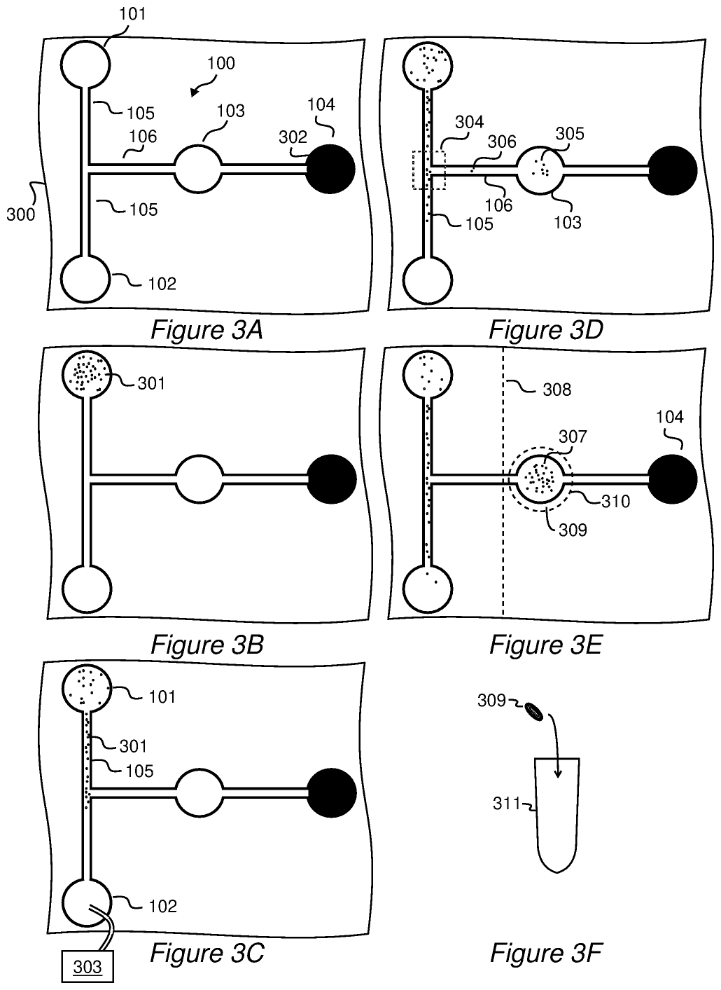

FIG. 2 shows another example microchip separation module 200. In general, well 201 corresponds with well 101 of module 100; well 202 corresponds with well 102; and channel 205 corresponds with channel 105. Exemplary cell separation modules may contain one, two, three, or more channels leading off of channels 105 or 205. In the case of module 100, a single channel 106 leads off of channel 105. In the case of module 200, two separate channels 206a and 206b branch off channel 205. The provision of multiple separate channels such as channels 206a and 206b allows for the isolation and separation of multiple cell types, each of the multiple branching channels being provided for use with a single cell type. Accordingly, channel 206a may be used for the separation of a first single cell type to well 203a. During the same microchip procedure, channel 206b may be used for the separation of a second single cell type to well 203b. As a non-limiting example, one of the channels 206a or 206b may be used for isolating spermatozoa cells, whereas the other of the channels 206b or 206a may be used for isolating epithelia cells. Further explanation of the process by which modules 100 or 200 may be used is explained below using FIGS. 3A and 3F.

FIG. 2 also illustrates that channels may be shaped differently depending on the embodiment. For instance, channels 206a and 206b include gradually enlarging sizes (e.g., widths or cross-sectional areas) as the channels reach their intersections with channel 205. By comparison, the channels 206a and 206b have smaller sizes as they reach their intersections with wells 203a or 203b, respectively. The enlarged channel sizes may be included to facilitate ease of transferring cells which are in the grasp of an optical tweezer from the channel 205 into either channel 206a or 206b.

FIGS. 3A to 3F collectively illustrate a general summary of an exemplary protocol for separating cells with the optical tweezer separation module 100 depicted by FIG. 1. Generally depicted is a cell separation module 100, which may be the only module on a single microchip 300, or else may be one of a plurality of modules on a single microchip. At first the microchip is primed with fluid. To prime the module, a liquid such as saline or water (e.g., 5-10 μL) may be deposited into the well 101. Capillary forces and/or a flow control device 303 draws water through the microfluidic channels and chambers. For this purpose, the wells 101 and 102 as well as the well 104 are open. An exemplary flow control device suitable for use with embodiments of this disclosure include but are not limited to, for example, a pressure driven pump or electric field driven pump. Exemplary pressure driven pumps include but are not limited to syringe pumps.

Once the channels and chambers are wetted, the chamber 104 is plugged, e.g., with a silicone mixture 302, as depicted by FIG. 3A. This step prevents cells from flowing from channel 105 (sometimes referred to herein as the “flow” channel) a significant distance into channel 106 (sometimes referred to herein as the “trap” channel). Some cells may drift a short distance into the channel 106. However, the length of channel 106 is selected so that cells which enter channel 106 merely by cell drift generally travel no more than half the length of channel 106, more preferably no more than a quarter of the length of the channel 106, even more preferably no more than one tenth the length of channel 106. In general, the distance cells may travel down channel 106 may be well less than one tenth the length of channel 106. The length of an exemplary trap channel 106 is, for example, at least 0.5 mm in length, at least 1 mm in length, at least 1.5 mm in length, or at least 2 mm in length.

Following a simple cell elution from a forensic swab or other substrate, a quantity (e.g., 1-2 μL) of a cell mixture 301 from which a particular cell type is to be separated is ejected into the chamber 101 on the separation module, as depicted by FIG. 3B. All cell types of the mixture 301 begin to flow through the channel 105 in the direction of chamber 102, as depicted by FIG. 3C, by the application of a negative pressure at the outlet 102 applied by the flow controller 303 such as a syringe or syringe pump system, for example. Note that flow controller 303 may be present for the entire method depicted by FIGS. 3A-3F, but because of space constraints of the page containing the illustrations, flow controller 303 is only literally depicted in FIG. 3C.

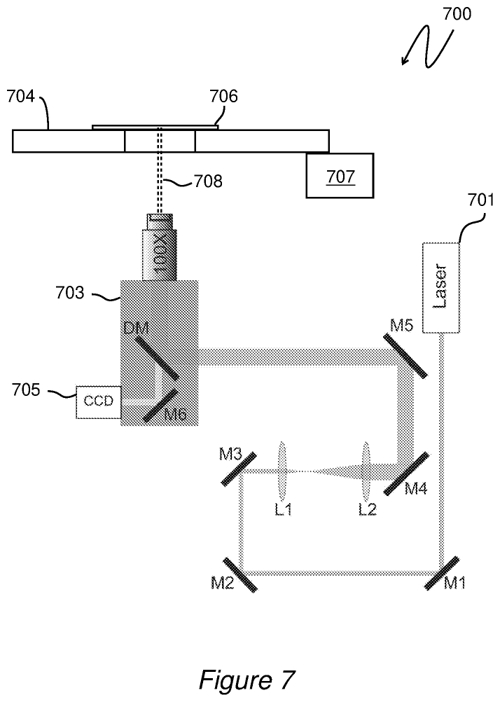

At the stage of FIG. 3C, if not earlier, the microdevice 300 may be placed on the stage of the inverted microscope (not depicted) that is adjacent to an optical tweezer device. The microscope stage may be used as the basis for changing the relative position of the microdevice relative to a beam from the optical tweezer device. One or more focused optical tweezer beams (e.g., a single beam or dual beam setup) are directed in the region 304 of the channel intersection formed by channels 105 and 106. The beam (or beams) are configured to trap individual cells. One at a time, trapped cells are transported down the “trap” channel 106 and deposited into the chamber 103, as illustrated by FIG. 3D, by removing the beam. Moving a cell with respect to the chip may be achieved by moving the chip relative the beam or vice versa. In some exemplary embodiments, the beam (or beams) may remain stationary relative to the outside environment. The microfluidic chip sits on a motorized microscope stage (see description of FIG. 7 below, for example). The stage may be controlled by, for example, a joystick controller or other type of controller. As the chip moves, the beam(s) and the cell held by the beam(s) of the optical tweezer apparatus does not move appreciably relative the outside environment. Within the microchip, however, the cell's position relative the chambers and channels of the microchip changes. For purposes of this disclosure, any description of moving/transporting cells relative the chambers/channels of a microdevice should be understood as the equivalent of moving the chambers/channels relative the cell (the difference being the frame of reference). Using, for example, the motorized stage to move the microchip while a tweezed cell is held by optical beam(s), the cell may be transported over very large distances within the chip. In the context of a microdevice, such a large distance may be a millimeter or more, for example.

The number of beams employed for optical tweezing may be varied according to the cell types to be separated. For example, two focused beams, separated by e.g. about 100 microns, is exemplary for trapping and moving relatively larger cells, such as epithelial cells. By comparison, a single beam setup is exemplary for comparatively smaller cells, such as sperm.

FIG. 3D shows a group of cells 305 already deposited in chamber 103 and another single cell 306 in the process of being transported down channel 106. After transporting a sufficient number of cells (e.g., ˜30) into the chamber 103, the microdevice 300 may be removed from the tweezer hardware apparatus. At the conclusion of this step, the desired type and quantity of cells 307 have been separated but must be transferred from the well 103. The desired quantity of cells 307 which have been separated may be visually verified, e.g., with the microscope which may accompany or include the stage used to move the microdevice relative to the OT beam(s), prior to moving to the next step.

For some embodiments it is desirable that subsequent steps of processing the separated cells 307, for instance cell lysis and DNA amplification, be performed in accordance with non-microfluidic techniques. In such cases, chamber 103 is physically separated from (most of) channel 106 and all of other elements 101, 102, and 105 which ever contained or may still contain a mixture of different cell types. One exemplary modality of separation is to cut the chip 300 along, e.g., the cut line 308 of FIG. 3E which intersects channel 106 near its end where it meets chamber 103. The cut line 308 may be configured as a quick-break snap cut which permits separation along the cut line 308 e.g. by the application of lightly applied forces to either side of the cut line 308. Another exemplary modality of separation is to excise a piece of the microfluidic chip 300 from a remainder of the chip. Excision may be performed by, for example, a punching action performed by a punch that severs the portion of the chip 309 enclosed by punch perimeter 310 of FIG. 3E from the remainder of the chip outside the punch perimeter 310. Then, as depicted by FIG. 3F, the separated portion 309 containing the captured cells well 103 is placed/deposited into a tube 311 or other non-microfluidic laboratory receptacle for offline procedural steps, e.g., cell lysis/DNA purification, DNA amplification, and capillary electrophoresis analysis. The size of the separated portion 309 of the chip may be, for example, less than 5 mm in the largest dimension, less than 4 mm in the largest dimension, less than 3 mm in the largest dimension, less than 2 mm in the largest dimension, or even less than 1 mm in the largest dimension. The size of the separated portion 309 of the chip may be, for example, between 0.5 and 5 mm in the largest dimension, between 0.5 and 4 mm in the largest dimension, between 0.5 and 3 mm in the largest dimension, between 0.5 and 2 mm in the largest dimension, or between 1 and 2 mm in the largest dimension, for example. The largest dimension may be, for example, a length or a diameter.

Prior to the separation of a part of the microdevice in FIG. 3E, a flushing step may be performed. For example, water is deposited in well 101 which is sucked through the flow channel 105 with the pump 303 until the fluid is removed from channel 105 and well 101. Water may be added to well 101 again, drawn through the channel 105, repeating the flushing multiple times, e.g., repeating 1-2 more times. This flushing step eliminates or substantially eliminates the presence of any cells from channel 105 and minimizes unwanted cells from getting drawn into chamber 103 during the step of separating chamber 103 from the remainder of the microchip.

While the above description of FIGS. 3A-3F is made with respect to module 100 of FIG. 1 for convenience, those of ordinary skill in the art will recognize substantially the same procedure may be used in embodiments with further branching channels off the flow channel, e.g., module 200. The optical tweezing and transfer to a distinct “captured cells” well may be repeated for each of the branching channels. Generally speaking, channel 106 corresponds with each of channels 206a and 206b; well 103 corresponds with each of wells 203a and 203b; channel 107 corresponds with channel 207a and 207b; and well 104 corresponds with wells 204a and 204b.

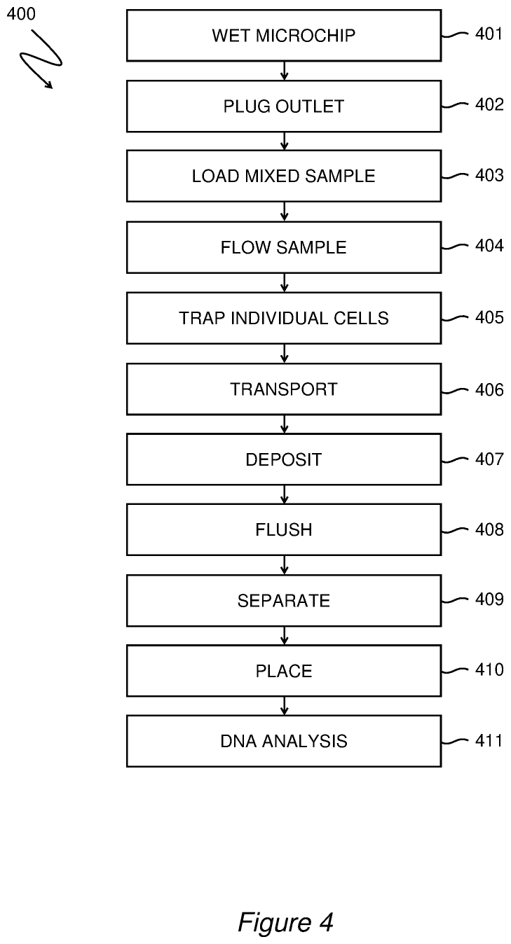

FIG. 4 depicts an exemplary method 400 for separating cells. Method 400 is alike to the method illustrated by FIG. 3, and those of ordinary skill in the art will recognize that in the practice of the invention according to this disclosure, various aspects of the methods illustrated by FIGS. 3 and 4 may be used in various combinations, including the possibility to omit or alter some steps while leaving others substantially as explicitly described herein, and including the possibility to add further steps to those explicitly described.

Block 401 is wetting of the microchip which occurs prior to loading of a mixed sample of cell types. A syringe pump (e.g., Harvard Apparatus 2000 PHD Infusion syringe pump) may be arranged next to a microscope or other platform to be used for optical tweezing. The pump may be filled with, for example, autoclaved water or other water of suitable purity. The syringe pump infusion rate is set prior to cell trapping and water is introduced into the chip. The entire device is filled with water. More specifically, up to all chambers and channels which will or may at some point in the procedure contain cells are filled so no significant air or other gas remains. A small droplet is formed on the opposite port from the syringe pump by pushing excess water through the flow channel with the syringe.

The outlet connected directly with the captured cells well is plugged at block 401. The outlet is open prior to wetting (block 401) to facilitate the flow of water to wet the “trap” channel. Air in the trap channel is able to evacuate from the chip via such outlet. The subsequent plugging at block 401 serves the benefit of preventing subsequent unintentional flow along the “trap” channel.

Next at block 403, a small (e.g., 1-5 microliters, e.g., 2.5 microliters) of sample is injected into the water droplet with, e.g., a micropipette. The syringe pump pulls backwards to introduce the sample into the microfluidic device's flow channel. A continuous low flow may be produced (block 404) and maintained while cells are being sorted. For example, the pusher block of the syringe pump may be configured to move with a set infusion rate to create a steady flow of sample across the flow channel. While such flow is occurring, optical tweezing is used to trap individual cells in the flow channel (block 405) and, manipulating a trapped cell with the laser, transported into designated secondary/trap channels (block 406). The laser deposits each trapped cell once it has been moved into an extraction region/chamber by releasing it from the optical tweezer (block 407).

Following the transport and depositing of a desired number of cells from the mixed sample in the first channel to the chamber containing only cells which have been deliberately deposited there by optical tweezing, the microchannel is flushed clear, e.g. with water, several times to eliminate unwanted cells from entering the chamber containing the separated cells (block 408). Following this, the chamber containing the separated cells is separated (e.g., removed) from the remainder of the microchip, in particular any parts of the microchip which contained or may still contain a sample of mixed cell types. Separation methods may vary among embodiments. As one option, the chamber with separated cells may be physically cut away (e.g., with a blade or blades, e.g., a knife or scissors) from a remainder of the microchip. Alternatively, the chamber with separated cells may be punched out from a remainder of the microchip, e.g., with a single-hole paper punch, an animal ear punch, or some other punch-action sampling tool. For instance, a 1.2 mm Harris Uni-Core™ punch commercially available from ThermoFisher Scientific at the time this disclosure was written serves as a non-limiting exemplary tool for performing the separating step of block 409. As indicated by block 410, the separated portion may then be placed in its entirety directly in some non-microfluidic laboratory receptacle, e.g., a tube, e.g., a centrifuge tube or microtube, for subsequent DNA analysis (block 411).

As mentioned in the preceding paragraph, after the depositing of a desired quantity of optically tweezed cells into the separate “captured cells” chamber (block 407), but prior to separating that chamber from a remainder of the microchip (block 409), a flushing step 408 may be performed in which the flow channel containing the flow of mixed cell types is emptied of cells and/or all liquid. The syringe pump (or other flow control device) may be used to draw all or substantially all remaining mixed sample in the flow channel out from the flow channel. The displaced sample fluid may be replaced by water alone, similar to the initial wetted state of the channel, or else replaced by air. The pump may draw from the channel until all or substantially all liquid and cells suspended in that liquid have been removed. Then, after such emptying of the mixed sample channel, the separating step of block 409 may be performed. This additional step may be advantageous in some embodiments to minimize any risk of cell types in the mixed sample flow channel accidently transferring to the separated portion of the microchip during manipulation of the microchip after optical tweezing is completed.

Generally, exemplary optical tweezing may be summarized as follows. Briefly, a laser beam with sufficient power (e.g., greater than 50 mW) is launched with various optical elements (mirrors, lenses, beamsplitters, etc.) into the back entrance of a high numerical aperture microscope objective. The light is focused to a diffraction limited spot with a diameter on the order of one micron. Objects with a higher index of refraction than the surrounding medium (e.g., cells in an aqueous buffer) are attracted to the center of the focal spot and held fixed. The spot can be moved relative to the surrounding environment or (as is more common) the surrounding environment is moved relative to the trapped cell. For purposes of this disclosure, it should be understood that discussion of moving a beam relative a microdevice encompasses moving the microdevice relative the beam, and vice versa. The movement of the spot enables transport of trapped cells in the microfluidic channel. The force applied should be sufficient to enable rapid transport of cells over millimeter distances (typical speeds of several hundred microns per second). In some embodiments, a selective dye may be included in the mixed sample loaded at stage 403 of FIG. 4. The dye may be selected to visually differentiate one cell type of interest from other cell types. Alternatively or additionally, a cell dissociation buffer (such as some commercially available at the time of writing of this disclosure) may be included in the sample loaded at block 403. A cell dissociation buffer may be desirable in some embodiments depending on cell types in the mixed sample. For example, epithelial cells sometimes exhibit clumping which can impair optical tweezing. A cell dissociation buffer may be added to minimize or eliminate cell clumping.

In some embodiments, an exemplary separation module such as module 100 of FIG. 1 or module 200 of FIG. 2 may be integrated into a larger microdevice that includes downstream modules. FIG. 5 is an exemplary fully integrated, i.e. multi-step, optical tweezer sexual assault microdevice 500. The microdevice 500 comprises the above-described separation module 100 depicted by FIG. 1 but may in the alternative have a module 200 of FIG. 2 or some other separation module (or multiple such modules) in accordance with this disclosure.

The downstream modules may include, for example, one or more of the following: cell lysis module, metering module, and DNA amplification module. In such a case, referring back to FIG. 3E, the chamber 104 may be physically unplugged, and the microdevice may then be loaded onto a rotational device if not already loaded onto such a device. A spinning motion may be supplied by the rotational device to move the captured cells from well 103 to the one or more downstream modules using centrifugal forces. The module 100 may include a channel 108 (see FIG. 1) allowing for the passage of the cells out from well 103 while remaining on chip.

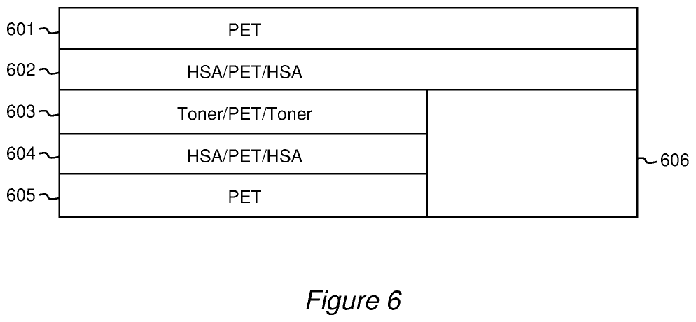

According to the illustrative example of FIG. 5, the microdevice 500 includes, in addition to a module 100 in accordance with FIG. 1, a cell lysis module 510 and a DNA amplification (“PCR”) module 520. A channel 108 leads off the module 100 to the further modules. Valves 531, 532, and 533 separate modules or parts of modules from one another. The valves may be, for example, closed and opened using a toner or similar, as described below in connection with FIG. 6. In addition or in the alternative, one or more of the valves may be configured according to valves described in U.S. patent application Ser. No. 16/484,142. The present disclosure incorporates by reference herein U.S. patent application Ser. No. 16/484,142, filed Aug. 7, 2019, published as US 2020/0023366, which reflects further work by inventors to the present application.

The exemplary cell lysis module 510 comprises a vent (e.g., inlet) 511, a reagent addition channel 512, a cell lysis chamber 513, a metering chamber 514, and excess storage chamber 515. The exemplary DNA amplification module 520 comprises a vent (e.g., inlet) 521, a PCR mix addition channel 522, a PCR/mixing chamber 523, and a (final) product chamber 524. At the conclusion of the relatively automated process which uses each of the modules 100, 510, and 520, amplicons can be retrieved from the chamber 524 for offline capillary electrophoresis analysis, for example.

FIG. 6 illustrates one exemplary embodiment for making a microchip for use according to this disclosure, including but not limited to those illustrated by FIGS. 1, 2, 3A-3F, and 5. FIG. 6 is a cross-section of a microdevice, omitting for simplicity the depiction of any channels or chambers (previously depicted, e.g., in FIGS. 1, 2, 3A-3F, and 5). Other alternatives may occur to those of skill in the art.

Whether modular (single step) or integrated (multi-step), an exemplary microdevice may be constructed as follows. The overall footprint of the chip may comprise five layers 601, 602, 603, 604 and 605 comprising or consisting of one or more polymers. For instance, overhead transparency sheets, or some other sheet made of polyethylene terephthalate (PET), are suitable. The two outermost layers 601 and 605 are plain PET, and the three inner layers include one layer 603 of PET coated in black printer toner sandwiched between two layers 602 and 604 coated in a heat-sensitive adhesive (HSA).

The black printer toner may be substituted by one or more other light absorbing materials that produce a localized temperature increase from exposure to the light beam. The function of such materials is to act as a removable barrier between chambers/channels. Valves, included e.g. to control the flow between modules, utilize the black toner of layer 603. At any specific valve, when the black toner layer is intact, the flow between modules is blocked and the valve is considered to be closed. To open a valve, a laser is used to “punch” a hole in the toner layer only (as only the black toner absorbs the laser's radiation), allowing fluid to flow through the valve. Fluidic movement may then be exerted by centrifugal force using a motor and heating/cooling may be performed by e.g. a Peltier clamp. The laser, motor, and Peltier clamp may all be mounted within a rotational hardware platform, with spin speeds, timing, temperatures, and laser activation controlled by software on a connected PC or other controller. The architecture (e.g., arrangement of chambers and channels) for all five layers is customized according to the particular microdevice to be made, e.g., any of the microdevices described above in connection with FIGS. 1-5. Auto-CAD software is suitable for drawing out the microchip architecture, and the resulting designs may be etched into the plastic materials for each layer using a laser cutter prior to the respective layers 601-605 being assembled together.

As a general example, for an exemplary optical tweezing cell separation module, layer 601 may contain the inlet and outlet port, and layer 602 may contain all of the flow/trapping/cell capture architecture (shown above by FIGS. 1 and 2, for example). When this single module is fully integrated into a multi-step microdevice (e.g., that which is depicted by FIG. 5), layers 602 and 604 may contain the necessary chambers and channels of each downstream module, with layer 603 providing valving between any module positioned in layer 602 from the immediately successive module positioned in layer 604. Once etching is completed for all layers 601-605, the layers may be aligned, assembled together, and fed through e.g. a benchtop laminator or other light heat source configured to provide sufficient heat to activate the HAS (without melting the polymer), thereby bonding all layers 601-605 together. Prior to bonding, a polygon (e.g., square or rectangle) may cut out of the materials of layers 603-605 in the middle of the microdevice to make way for a transparent cover, e.g., a plastic microscope cover slip 606 or other transparent material. The cut-out and corresponding cover slip 606 allows for the device to be optically compatible with, e.g., both a microscope and a laser (e.g., a dissection laser) used for cell separation. The laser light may be directed through the cover slip 606 to optically tweeze cells in channels and chambers belonging to layer 602. FIG. 5 illustrates an exemplary cover slip footprint 530 relative to a remainder of the microdevice 500.

In an aspect of some exemplary embodiments, exemplary microdevices may be configured to contain no brittle materials such as glass, in particular in the region 309 and immediately adjacent rejections to region 309. Glass and other brittle materials are not conducive to desirable forms of separating the chamber 103 from a remainder of the microdevice. For instance, attempting to punch out a polygon (e.g., circle) from a glass layer is desirably avoided. Non brittle materials such as polymer or polymer-based materials are preferred for the whole microdevice, or at least the part of the microdevice which encloses chamber 103.

FIG. 7 shows schematically a system 700 of apparatuses (not to scale) usable for the above-described exemplary methods. The system 700 includes, for example, one or more lasers 701; optics such as, for illustrative purposes, mirrors M1, M2, M3, M4, M5, M6, and dichroic mirror DM and lenses L1 and L2; a microscope 703, and a mechanical platform 704 usable to support and move a microdevice 706 relative the one or more beams 708 used for optical tweezing. Movement of the stage/platform 707, which may be separate from or part of microscope 703, may be controlled with a controller 707. An imager such as a camera such as charge-coupled device (CCD) 705, which may be separate from or a part of microscope 703, may be included and used for the OT process and visual confirmation of reaching a desired number cells transferred to a captured cells chamber of the microdevice 706.

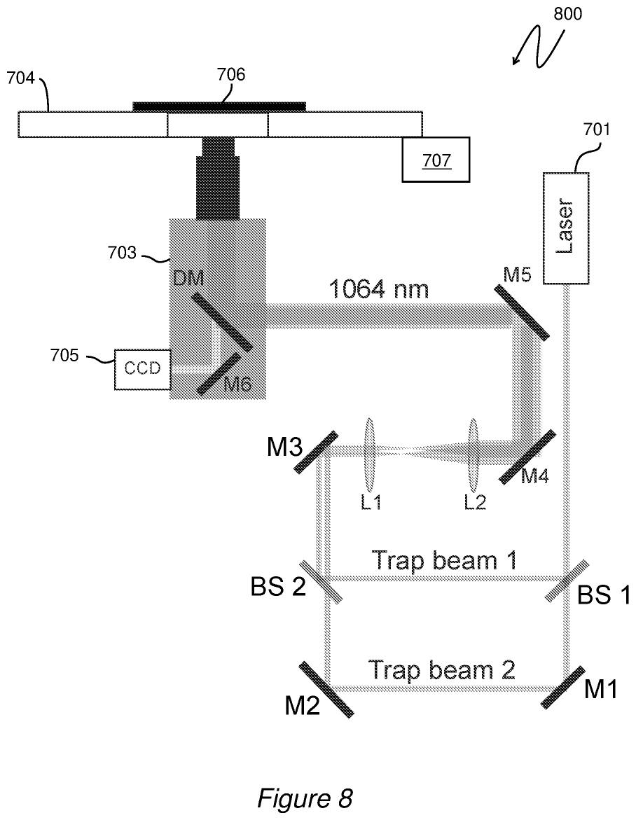

FIG. 8 shows schematically a system 800 which is a modification from system 700 to provide an exemplary dual trap setup. FIG. 8 shows a dual trap setup where two beamsplitters (BS1 and BS2) are used to separate the beams as shown.

In some aspects, the cell source may be a mammal, such as a human, and the particular source of the cells to be collected is the surface of a tissue, e.g. vaginal tissue, anal tissue, nasal tissue, tissue of the nasopharyngeal cavity, etc. In particular aspects, the human is a (female or male) victim of sexual assault and the cells are collected from the vagina and/or the anus and/or the oral cavity i.e. typical areas of penetration/ejaculation by a perpetrator. However, cells may be taken from any part of the body (e.g. a surface or crevice), that is considered likely to harbor cells suitable for analysis, or from an article of clothing, or from a “wearable” item such as a tampon, a bandage, etc. Those of skill in the art are familiar with the use of collection devices such as swabs to collect cell samples. Examples of suitable collection devices are disclosed, for example, in US patent application pre-grant publications 2013/288863 and 2005/0252820, etc. and are readily commercially available.

In some aspects, prior to analyzing the sample using the microfluidic device described herein, the sample is pre-processed, e.g. to remove unwanted sample components (e.g. debris, tissue fragments, etc.), unwanted cell types (e.g. red blood cells,) or other contaminants, e.g. by centrifugation, filtering, etc. The cells may also be transferred to a biologically compatible liquid carrier and the liquid carrier may be loaded into the device. However, in a time-saving aspect, a cell collection surface or portion of a cell collection surface may be loaded directly into the device, e.g. into chamber 101 or 201.

In order to conduct a successful analysis, the number of cells of interest in a sample to be processed generally ranges from about 10 to 100, and is preferably at least about 10 of each type of cell that is, or is suspected of being, present in a sample, and more preferably at least about 20, or 30, or more, e.g., up to at least 100. For example, for the analysis of sperm, the sample may preferably contains at least about 100 sperm cells. However, those of skill in the art will recognize that fewer cells can be separated, e.g. as few as about 10, 20, 30, 40, 50, 60, 70, 80 or 90, depending on the subsequent analysis to be performed on the group of cells. By “about” or “approximately”, we mean within +/−10% of the indicted value, or less, e.g. within +/−9, 8, 7, 6, 5, 4, 3, 2, or 1% of the indicated value.

Once the collection surface of a collection device is obtained, cells may be eluted, rinsed or otherwise removed from the collection surface and transferred into a predetermined quantity of a suitable biologically compatible medium or buffer. Mixing (agitation) may ensue (e.g. by rocking a support or platform onto which the microdevice is attached or by movement of the collection device). Movement may be induced by a user and/or induced by, e.g., a motor or servomotor. Alternatively, a user of the microdevice may actively flush liquid across the collection surface to dislodge cells. Since the device described herein is a microdevice, the amount of liquid used may be generally in the range of from about 10 μl to about 20 μl, (e.g. about 10, 11, 12, 13, 14, 15, 16, 17, 18, 19 or 20 μl, and is typically about 12 to 18 μl, such as about 15 μl.

Suitable biologically (physiologically) compatible media or buffers for containing cells from the biological sample include but are not limited to neutral cell buffers such as water, phosphate buffered-saline, or detergent or enzyme-containing cell lysis buffer.

Where a range of values is provided, it is understood that each intervening value between the upper and lower limit of that range (to a tenth of the unit of the lower limit) is included in the range and encompassed within the invention, unless the context or description clearly dictates otherwise. In addition, smaller ranges between any two values in the range are encompassed, unless the context or description clearly indicates otherwise.

Unless defined otherwise, all technical and scientific terms used herein have the same meaning as commonly understood by one of ordinary skill in the art to which this invention belongs. Representative illustrative methods and materials are herein described; methods and materials similar or equivalent to those described herein can also be used in the practice or testing of the present invention.

All publications and patents cited in this specification are herein incorporated by reference as if each individual publication or patent were specifically and individually indicated to be incorporated by reference, and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual dates of public availability and may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as support for the recitation in the claims of such exclusive terminology as “solely,” “only” and the like in connection with the recitation of claim elements, or use of a “negative” limitations, such as “wherein [a particular feature or element] is absent”, or “except for [a particular feature or element]”, or “wherein [a particular feature or element] is not present (included, etc.)”. . . “.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method may be carried out in the order of events recited or in any other order which is logically possible.

While the invention has been described in terms of its several exemplary embodiments, those skilled in the art will recognize that the invention can be practiced with modification within the spirit and scope of the appended claims. Accordingly, the present invention should not be limited to the embodiments as described above, but should further include all modifications and equivalents thereof within the spirit and scope of the description provided herein.

What is claimed is:

1. A method of separating cells from a mixed biological sample, comprising
trapping individual cells from a cell mixture in a first channel with one or more optical tweezer beams;
transporting the trapped individual cells down a second channel;
depositing the transported individual cells in a chamber;
separating the chamber containing the deposited individual cells from the first channel; and
placing the separated chamber into a non-microfluidic receptacle for subsequent DNA analysis.

2. The method of claim 1, further comprising, as the subsequent DNA analysis, steps of
cell lysis of the deposited individual cells;
amplification of DNA obtained from the cell lysis; and
identification of a human from the DNA.

3. The method of claim 1, wherein the steps of trapping, transporting, and depositing are performed on a single microfluidic chip.

4. The method of claim 3, wherein the step of separating comprises excising a piece of the microfluidic chip from a remainder of the microfluidic chip.

5. The method of claim 4, wherein the excising is performed by a punching action.

6. The method of claim 3, wherein the step of separating comprises cutting a piece of the microfluidic chip from a remainder of the microfluidic chip.

7. The method of claim 1, wherein the non-microfluidic receptacle is a tube.

8. The method of claim 1, further comprising maintaining a flow of the cell mixture in the first channel during the trapping step.

9. The method of claim 1, further comprising flushing the first channel prior to the separating step.

10. The method of claim 1, further comprising wetting the first channel and the second channel prior to the trapping step.

11. A method of separating cells from a mixed biological sample, comprising
trapping individual cells of a first cell type from a cell mixture in a first channel by optical tweezing;
transporting the trapped individual cells of the first cell type down a second channel;
depositing the transported individual cells of the first cell type in a first chamber;
trapping individual cells of a second cell type from the cell mixture in the first channel by optical tweezing;
transporting the trapped individual cells of the second cell type down a third channel;
depositing the transported individual cells of the second cell type in a second chamber;
separating the first and second chambers from the first channel; and
placing each of the first and second chambers into respective first and second non-microfluidic receptacles for subsequent DNA analysis.

12. The method of claim 11, further comprising, as the subsequent DNA analysis, for each of the first and second cell types, steps of
cell lysis of the deposited individual cells;
amplification of DNA obtained from the cell lysis; and
identification of a human from the DNA.

13. The method of claim 11, wherein the steps of trapping, transporting, and depositing of the individual cells of the first cell type and the steps of trapping, transporting, and depositing of the individual cells of the second cell type are performed on a single microfluidic chip.

14. The method of claim 13, wherein each step of separating comprises excising a respective piece of the microfluidic chip from a remainder of the microfluidic chip.

15. The method of claim 14, wherein the excising is performed by a punching action.

16. The method of claim 13, wherein each step of separating comprises cutting a respective piece of the microfluidic chip from a remainder of the microfluidic chip.

17. The method of claim 11, wherein the non-microfluidic receptacles are tubes.

18. The method of claim 11, further comprising maintaining a flow of the cell mixture in the first channel during the trapping steps.

19. The method of claim 11, further comprising flushing the first channel prior to either of the separating steps.

20. The method of claim 11, further comprising wetting the first, second, and third channels prior to either of the trapping steps.

21. A microdevice, comprising
a first well and a second well;
a first channel connecting the first well and second well;
one or more branching channels which branch from the first channel between the first and second wells;
one or more collecting chambers, wherein the one or more branching channels each connects the first channel with a respective one of the one or more collecting chambers; and
a transparent cover permitting passage of one or more optical tweezer beams into at least the first channel, the one or more branching channels, and the one or more collecting chambers.

22. The microdevice of claim 21, wherein the one or more branching channels includes at least two branching channels.
